(19) United States
(12) Patent Application Publication
(10) Pub. No.: US 2015/0002848 A1
(43) Pub. Date: Jan. 1, 2015

(54) DEVICE AND METHOD FOR OPTICAL INSPECTION OF A SAMPLE

(71) Applicant: FEMTOLASERS PRODUCTIONS GMBH, Komeuburg (AT)

(72) Inventor: Gabriel-Florin Tempea, Wien (AT)

(21) Appl. No.: 14/372,093

(22) PCT Filed: Jan. 15, 2013
(86) PCT No.: PCT/AT2013/050009

§ 371 Date: Jul. 14, 2014

(30) Foreign Application Priority Data
Jan. 17, 2012 (AT) A 47/2012

(51) Int. Cl. G01J 3/45; G01N 21/25

(52) U.S. Cl. CPC G01J 3/45; G01N 21/25; G01J 2003/283
USPC 356/451

(57) ABSTRACT

Method and device for optical inspection of a sample using spectral interferometry, wherein a beam (2″) emitted by a radiation source (1) is directed onto the sample (5) and a reference beam (2′) is directed onto a reference sample (4), and the spectral interference of both beams after being reflected on the samples or after passing the samples is recorded by means of a spectrograph (6); the interferogram I(ω) thus obtained is numerically derived with respect to the angular frequency ω. For the function I′(ω) thus obtained the zeros ωᵢ are calculated numerically as solutions to the equation I′(ω)=0 and the frequency-dependent group delay τ(ω) is then calculated from the zeros ωᵢ according to the equation τ(ωₙ)=π/(ωᵢ₊₁−ωᵢ), wherein i=1, 2 . . . and ωₙ=(ωᵢ₊₁+ωᵢ)2.

The invention relates to a method for the optical inspection of a sample by means of spectral interferometry, as well as a device for carrying out such a method.

Spectral interferometry is a very important measuring method for optical and laser technology. It is used inter alia for determining the surface quality of optics, in spectroscopy, for dispersion measurements (V. N. Kumar and D. N. Rao, “Using interference in the frequency domain for precise determination of thickness and refractive indices of normal dispersive materials,” J. Opt. Soc. Am. B 12, 1559-1563 <1995>), but also—in connection with a non-linear effect—for the purpose of characterising pulse duration (C. Iaconis and I. A. Walmsley, “Spectral Phase Interferometry for Direct Electric-field Reconstruction of Ultrashort Optical Pulses,” Optics Letters 23, 792-794 <1998>).

Two light beams that are temporally delayed relatively to one another are spatially superposed and the intensity of the superposed beams is measured in a spectrally resolved manner. The measured spectrum has a modulation (spectral interference pattern); the delay between the two light signals and the difference between the spectral phases of the two light signals can be determined from this spectral interference pattern.

This information is determined from the spectral interferogramme by means of a numerical method that is known per se and is based on the Fast Fourier transform (FFT) (“Interferogram Analysis”, D. W. Robinson and G. T. Reid, Eds., Institute of Physics Publishing, Bristol <1993>, pages 141-193).

For some uses (e.g. dispersion measurements) it is however necessary to determine not just the spectral phase, but also the group delay dispersion (GDD, the second derivative of the phase according to the angular frequency). This GDD can obviously be determined by means of a double numerical derivation of the measured spectral phase. The numerical derivation is however known to be an unstable numerical method and the error propagation analysis shows that small measuring errors in the spectral phase can lead to unreliably high error rates in the GDD (A. N. Tikhonov and V. Y. Arsenin, “Solutions of Ill-Posed Problems”, Wiley <1977>).

It would therefore be advantageous to determine the GDD or at least the GD (the simple derivation of the spectral phase according to the angular frequency) from the measurement directly, and it is the object of the invention to enable this in a simple manner.

To achieve this object, the invention provides a method like that specified at the beginning, which is characterised in that a beam emitted from a radiation source is directed onto the sample and a reference beam is directed onto a reference sample and the spectral interference of the two beams after reflection at the samples or passing the samples is recorded by means of a spectrograph, and in that the thus-obtained interferogramme I(ω) is numerically derived according to the angular frequency ω, whereupon the zeroes ωᵢ are numerically calculated for the thus-obtained function I′(ω) as solutions of the equation I′(ω)=0 and then the frequency-dependent group delay τ(ω) is calculated from the zeroes ωᵢ in accordance with the equation τ(ωₙ)=π/(ωᵢ₊₁−ωᵢ), where i=1, 2 . . . and ωₙ=(ωᵢ₊₁+ωᵢ)2.

Here, it is furthermore simply possible if the frequency-dependent group delay dispersion GDD is calculated by numerical derivation of the group delay τ(ω) according to the angular frequency ω.

It is also beneficial if the spectral phase is determined by numerical integration of the group delay τ(ω) over the angular frequency. In this case it is furthermore advantageous, if the time-dependent phase is determined by means of Fourier transform of a predetermined spectrum, taking the determined spectral phase into account; or if the time-dependent intensity of a beam pulse is determined by Fourier transform of a predetermined spectrum, taking the determined spectral phase into account.

A laser (pulse) source or a light bulb or else a light emitting diode is for example used as radiation source or light source.

An advantageous application of the invention is characterised in that a thin-layer coating on a substrate is investigated as a sample, the spectral interference of a beam reflected by a thin layer on a substrate being recorded with a beam reflected by a reference reflector.

The device according to the invention for carrying out the present method is correspondingly characterised by an interferometer apparatus having a radiation source, having means, e.g. a radiation splitter, for creating a reference beam and a measuring beam, and having a spectrograph, to which a computing unit is connected, which is configured to numerically derive an interferogramme, which is obtained with the aid of the spectrograph, according to the angular frequency, whereupon the zeroes ωᵢ are numerically calculated for the thus-obtained function I′(ω) as solutions of the equation I′(ω)=0 and then the frequency-dependent group delay τ(ω) is calculated from the zeroes ωᵢ in accordance with the equation τ(ωₙ)=π/(ωᵢ₊₁−ωᵢ), where i=1, 2 . . . and ωₙ=(ωᵢ₊₁+ωᵢ)/2 (i.e. ωₙ is the average value of ωᵢ₊₁ and ωᵢ).

In this case, it is advantageous if the computing unit is furthermore set up to calculate the frequency-dependent group delay dispersion GDD by numerically deriving the group delay τ(ω) according to the angular frequency ω.

Furthermore, it is beneficial if the computing unit is set up to determine the spectral phase by numerical integration of the group delay τ(ω) over the angular frequency.

It is also advantageous, if the computing unit furthermore has a Fourier transform module, in order to determine the time-dependent phase by means of Fourier transform of a predetermined spectrum, taking the determined spectral phase into account; also, the computing unit can have a Fourier transform module, in order to determine the time-dependent intensity of a beam pulse by Fourier transform of a predetermined spectrum, taking the determined spectral phase into account.

In the case of a reflective investigation of a sample, a reference mirror can be provided for reflecting the reference beam.

The invention is therefore based on a technology of a direct spectral evaluation (DSE), which compared to the conventional method based on FFT (see above, “Interferogram Analysis”, D. W. Robinson and G. T. Reid), also has the following advantages: (1) The use of FFT is not necessary and the number of mathematical operations is much smaller; thus, the DSE method is much faster. The fact that the FFT does not have to be used also means that it is not necessary to interpolate and to extrapolate the measured interferogramme in order to fulfil the conditions required for the FFT. As a result, the number of values that have to be processed is smaller approximately by a factor of 4. Furthermore, the double FFT is replaced by a numerical derivation and an interpolation. As a result, the DSE method is faster than the conventional method at least by a factor of 100. Thanks to this computing speed, the method can be used in quasi real-time for characterising the dispersion in dynamic processes, e.g. for the purpose of monitoring the growth of the layer thicknesses of dispersive mirrors during the coating process.

(2) The suggested method allows the direct evaluation of the group delay (GD, the first derivative of the spectral phase according to the angular frequency); thus numerical derivation must be used only once to obtain the GDD. As a result, the unfavourable propagation of the measuring errors by means of the derivation of the phase is substantially reduced.

The invention is explained in more detail hereinafter on the basis of preferred exemplary embodiments and with reference to the drawing. In the figures:

FIG. 1 shows an example of a spectral interferogramme, namely the intensity I(ω) in arbitrary units, over the wavelength λ (in nm);

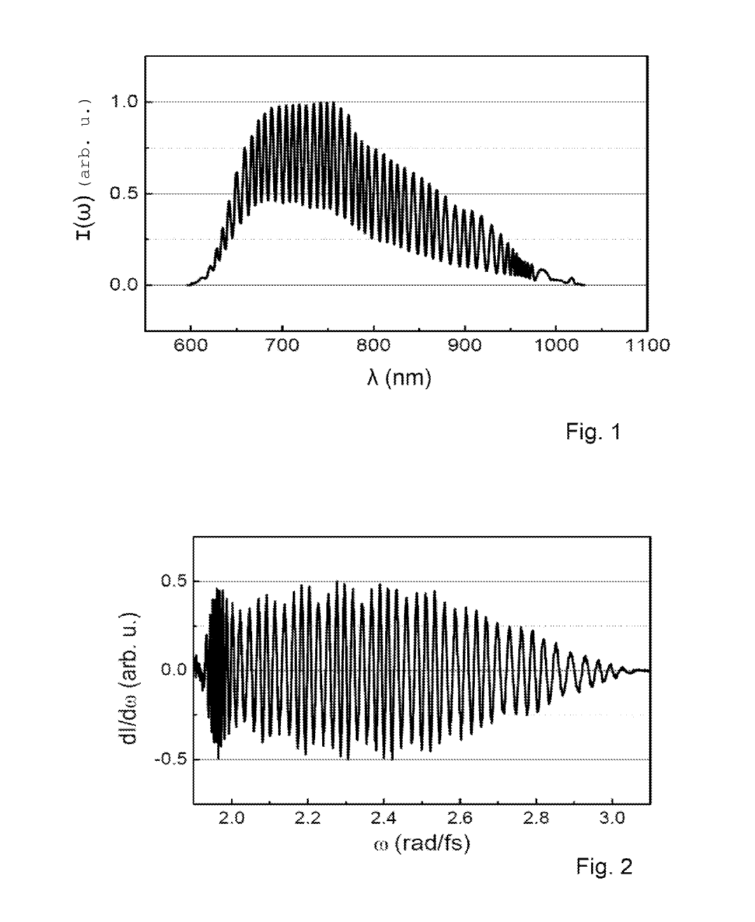

FIG. 2 shows the derivative I′(ω) of this interference signal I(ω) according to the angular frequency, that is to say I′(ω)=dI/dω, over the angular frequency ω (in rad/fs);

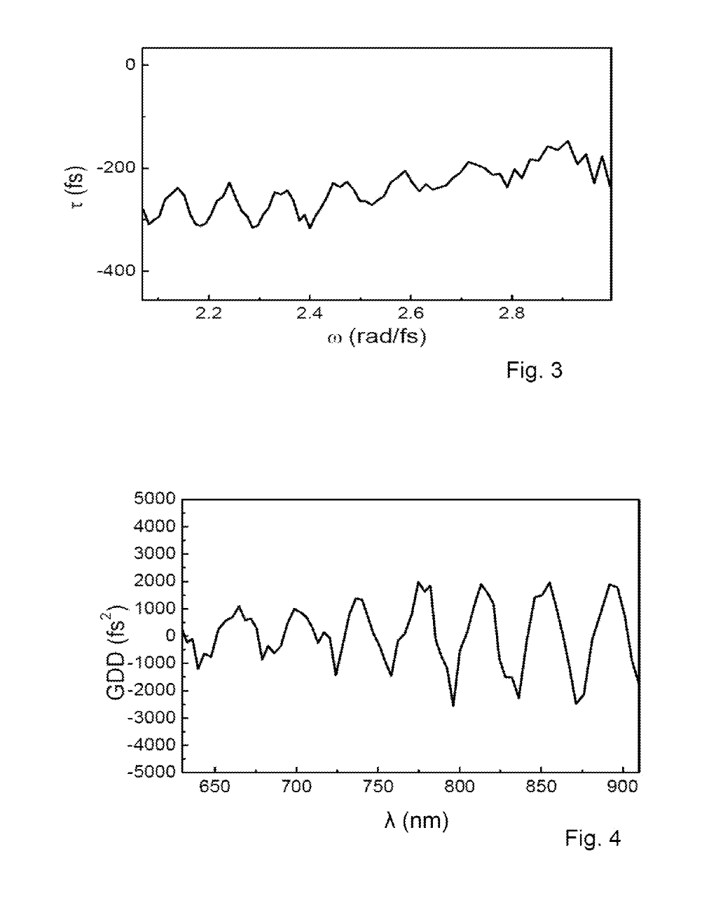

FIG. 3 shows the group delay τ(in fs) calculated from the interference signal I(ω) of FIG. 1 over the angular frequency ω in a graph;

FIG. 4 shows the total group delay dispersion GDDₜ (in fs²) calculated from the interference signal I(ω) over the wavelength λ (in nm), in a graph;

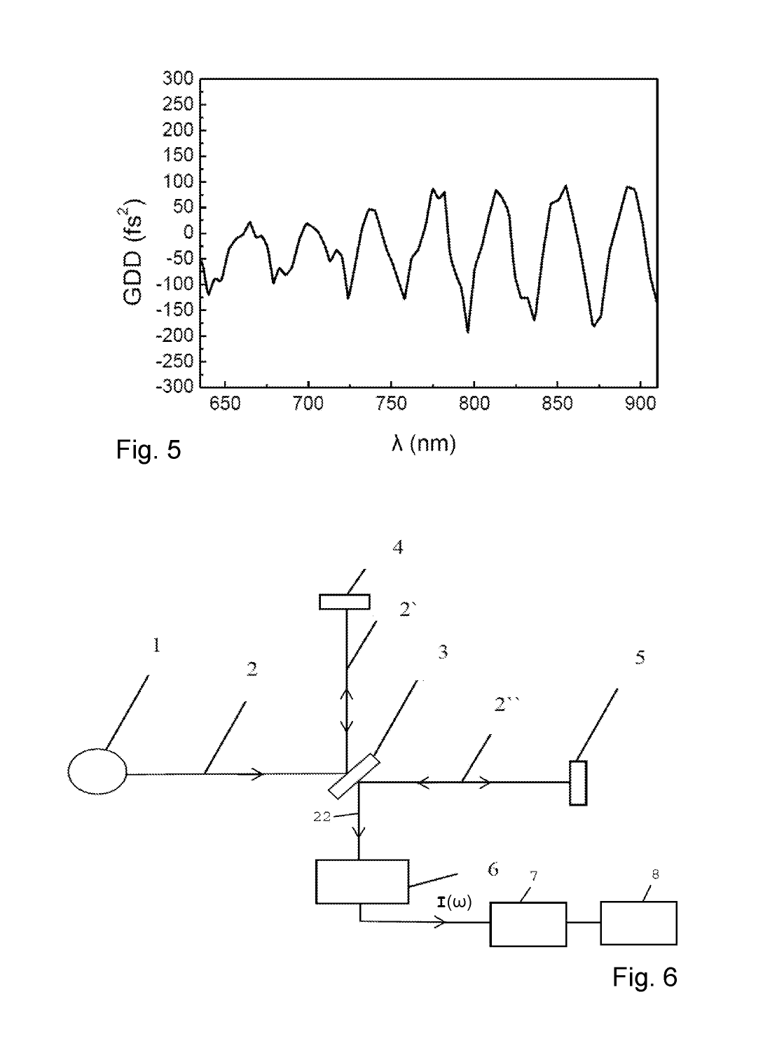

FIG. 5 shows the group delay GDD_{S} calculated from I(ω), which is brought about by a sample mirror for each reflection, in a graph; and

FIG. 6 schematically shows a device having an interferometer.

FIG. 1 shows a typical spectral interferogramme, i.e. interference signal I(ω), specifically in arbitrary units (“arb. u”). This spectral interference signal I(ω) is derived according to the angular frequency ω. The function I′(ω) created as a result is illustrated in FIG. 2 on the basis of the example spectrum from FIG. 1. The zero crossings wᵢ of the function I′(ω) (i.e. ωᵢ=all solutions of the equation I′(ω)=0 in the frequency range relevant for the measurement) are determined by means of a numerical algorithm that is known per se (e.g. by linear or non-linear interpolation).

The group delay τ is calculated from the angular frequency values ωᵢ as a function of the angular frequency ω as follows: τ(ωₙ)=π/(ωᵢ₊₁−ωᵢ), where ωₙ=(ωᵢ₊₁+ωᵢ)2.

The group delay values τ calculated in this manner from the interferogramme depicted in FIG. 1 are illustrated in FIG. 3.

If required for the use, the group delay dispersion GDD can be calculated from the group delay τ by means of numerical derivation. This GDD is illustrated in FIG. 4 for the interferogramme depicted in FIG. 1.

Owing to the design of the white light interferometer that was used for the measurement shown here, the total dispersion GDDₜ is composed as follows: GDDₜ=16*GDD_{S}+2*GDD_{FS}, GDD_{S} being the dispersion that is caused during the reflection on a sample mirror and GDD_{FS} is the dispersion of a glass plate made from quartz glass (fused silica) with a thickness of 6.35 mm. Thus, the dispersion of the sample mirror GDD_{S} (which is brought about for a reflection) can be calculated as follows: GDD_{S}=(GDDₜ−2*GDD_{FS})/16. The thereby-obtained dispersion GDD_{S} of the sample mirror to be characterised is illustrated in FIG. 5.

FIG. 6 shows a possible embodiment of a Michelson interferometer for creating the interferogramme I(ω). Both this design and other embodiments of a Michelson interferometer (e.g. with multiple reflections on the sample mirror) and other types of interferometers that are known per se (such as e.g. Mach-Zehnder interferometers) can be used, for example in order—according to FIG. 6—to measure a mirror 5.

In detail, FIG. 6 shows a schematic illustration of a Michelson interferometer for spectral interferometry, a beam 2 created using a light source 1 being divided by means of a beam splitter 3. A reference beam 2′ is reflected by means of a reference mirror 4 (the dispersion characteristics of which are well known), which is used as rear reflector. A measuring beam 2″ is reflected by the mirror 5 to be measured. The mirror 5 can also be installed as a multi-folding mirror, in order to increase the GDD brought about thereby and thus the measuring accuracy. The reference beam 2′ and the measuring beam 2″ are brought back to spatial superposition by means of the beam splitter 3, cf. beam 22. The spectral interferogramme is recorded from this beam 22 by means of a spectrograph 6.

The difference between the group delay of the reference beam 2′ and the group delay of the measuring beam 2″ can be calculated from the thus-obtained interference signal I(ω), as explained above. To this end, a correspondingly configured computing unit 7 is connected to the spectrograph 6; the results, e.g. GD, GDD, etc., are output, e.g. displayed and/or printed, by means of an output unit 8.

Thanks to the high measuring and evaluation speed, the described technology can be used e.g. for monitoring a coating process, in the case of a thin-layer coating of a substrate, for example in the production of a dispersive mirror, in real time during the coating process.

1. A method for determining at least the group delay of a sample by means of spectral interferometry, wherein a beam emitted from a radiation source is directed onto the sample and a reference beam is directed onto a reference sample and the spectral interference of the two beams after reflection at the samples or passing the samples is recorded by means of a spectrograph wherein the thus-obtained interferogramme I(ω) is numerically derived according to the angular frequency ω, whereupon the zeroes ωᵢ are numerically calculated for the thus-obtained function I′(ω) as solutions of the equation I′(ω)=0 and then the frequency-dependent group delay τ(ω) is calculated from the zeroes ω, in accordance with the equation τ(ωₙ)=π/(ωᵢ₊₁−ωᵢ), where i=1, 2 . . . and ωₙ=(ωᵢ₊₁+ωᵢ)2.

2. The method according to claim 1, wherein the frequency-dependent group delay dispersion (GDD) is calculated by numerical derivation of the group delay τ(ω) according to the angular frequency ω.

3. The method according to claim 1, wherein the spectral phase is determined by numerical integration of the group delay τ(ω) over the angular frequency.

4. The method according to claim 3, wherein the time-dependent phase is determined by means of Fourier transform of a predetermined spectrum, taking the determined spectral phase into account.

5. The method according to claim 3, wherein the time-dependent intensity of a beam pulse is determined by Fourier transform of a predetermined spectrum, taking the determined spectral phase into account.

6. The method according to claim 1, wherein a laser pulse source or a light bulb or else a light emitting diode is used as radiation source.

7. The method according to claim 1, wherein a thin-layer coating on a substrate is investigated as a sample, wherein the spectral interference of a beam reflected by a thin layer on a substrate is recorded with a beam reflected by a reference reflector.

8. A device for carrying out a method according to claim 1, having an interferometer apparatus having a radiation source, having means for generating a reference beam and a measuring beam, and having a spectrograph, wherein a computing unit is connected to the spectrograph, which computing unit is configured to numerically derive an interferogramme I(ω), which is obtained with the aid of the spectrograph, according to the angular frequency ω, whereupon the zeroes ωᵢ are numerically calculated for the thus-obtained function I′(ω) as solutions of the equation I′(ω)=0 and then the frequency-dependent group delay τ(ω) is calculated from the zeroes ωᵢ in accordance with the equation τ(ωₙ)=π(ωᵢ₊₁−ωᵢ), where i=1, 2 . . . and ωₙ=(ωᵢ₊₁+ωᵢ)/2.

9. The device according to claim 8, wherein the computing unit is furthermore set up to calculate the frequency-dependent group delay dispersion GDD by numerically deriving the group delay τ(ω) according to the angular frequency ω.

10. The device according to claim 8, wherein the computing unit is set up to determine the spectral phase by numerical integration of the group delay τ(ω) over the angular frequency.

11. The device according to claim 10, wherein the computing unit furthermore has a Fourier transform module, in order to determine the time-dependent phase by means of Fourier transform of a predetermined spectrum, taking the determined spectral phase into account.

12. The device according to claim 10, wherein the computing unit has a Fourier transform module, in order to determine the time-dependent intensity of a beam pulse by Fourier transform of a predetermined spectrum, taking the determined spectral phase into account.

13. The device according to claim 8, wherein a laser pulse source or a light bulb or else a light emitting diode is provided as radiation source.

14. The device according to claim 8, comprising a reference mirror for reflecting the reference beam.

15. The device according to claim 8, wherein the means for creating a reference beam and a measuring beam is formed by a radiation splitter.
